(19) United States
(12) Patent Application Publication
(10) Pub. No.: US 2015/0253842 A1
(43) Pub. Date: Sep. 10, 2015

(54) SEMICONDUCTOR DEVICE, AND POWER CONTROL METHOD FOR USBOTG

(71) Applicant: Kabushiki Kaisha Toshiba, Tokyo (JP)

(72) Inventor: Naoya Murata, Yokohama Kanagawa (JP)

(21) Appl. No.: 14/477,624

(22) Filed: Sep. 4, 2014

(30) Foreign Application Priority Data
Mar. 10, 2014 (JP) 2014-046719

(51) Int. Cl. G06F 1/32

(52) U.S. Cl. CPC G06F 1/3287

(57) ABSTRACT

A semiconductor device according to an embodiment includes a transmission circuit unit including a physical unit configured to receive, from a connector for connecting to an external appliance configured to transmit a power supply signal and an identification signal, the power supply signal and the identification signal, the transmission circuit unit being configured to be able to perform data communication with the external appliance, and a power control unit configured to perform power control based on a power saving mode and a normal mode, the power control unit being configured to stop power supply to the transmission circuit unit in the power saving mode, and, to detect a connection event of the external appliance to the connector based on the power supply signal and the identification signal and to start power supply to the transmission circuit unit.

### CROSS-REFERENCE TO RELATED APPLICATION

This application is based upon and claims the benefit of priority from the Prior Japanese Patent Application No. 2014-046719, filed on Mar. 10, 2014; the entire contents of which are incorporated herein by reference.

### FIELD

An embodiment described herein relates generally to a semiconductor device, and a power control method for a USBOTG.

### BACKGROUND

Conventionally, USBs (universal serial buses) are widespread as a serial bus standard for connecting a peripheral appliance to an information appliance. USBs are configured of a host and a device, and a device (a USB device) provided to a peripheral appliance is controlled by a host (a USB host) provided to a personal computer or the like, and communication is performed between the USB host and the USB device.

Also, in recent years, a USB on-the-go (OTG) including the function of both the USB host and the USB device (hereinafter, both will be referred to as “USB appliance”) has started to be used to enable communication between peripheral appliances. By mounting an LSI having an OTG controller function according to USB 2.0 standard in a peripheral appliance and connecting peripheral appliances by a USB, communication between the peripheral appliances is enabled. The OTG controller sets its own device as the device when the connector of a USB host of another appliance is connected to the USB connector of its own device, and sets its own device as the host when the connector of a USB device of another appliance is connected to the USB connector of its own device. To perform such setting, the OTG controller has a function of detecting a connection event of another USB appliance.

Now, as a peripheral appliance, a mobile terminal such as a mobile phone or a digital camera is conceivable. With such a mobile terminal which can be driven by a battery, power saving of the LSI that is mounted is an important issue. This type of LSI includes a power saving mode for reducing the amount of power consumption, and may be set to a standby state where each functional block mounted is caused to perform only the minimum function until a necessary event occurs.

However, with a USBOTG, a connection event has to be detected, and thus, even in a power saving mode where each functional block in an LSI is in a standby state, power supply and clock supply to the OTG controller are necessary, and there is an issue that the amount of power consumption at the time of the power saving mode of the LSI is great.

### BRIEF DESCRIPTION OF THE DRAWINGS

FIG. 1 is a block diagram showing a semiconductor device according to a first embodiment of the present invention;

FIG. 2 is a flowchart for describing an operation of the first embodiment;

FIG. 3 is a block diagram showing a second embodiment of the present invention; and

FIG. 4 is a flowchart for describing an operation of the second embodiment.

### DETAILED DESCRIPTION

According to an embodiment, a semiconductor device includes a transmission circuit unit including a physical unit configured to receive, from a connector for connecting to an external appliance configured to transmit a power supply signal and an identification signal, the power supply signal and the identification signal, and a transmission control unit configured to be able to detect connection of the external appliance based on the power supply signal and the identification signal received by the physical unit, the transmission circuit unit being configured to be able to perform data communication with the external appliance, and a power control unit configured to perform power control based on a power saving mode and a normal mode, the power control unit being configured to stop power supply to the transmission circuit unit in the power saving mode, and, to detect a connection event of the external appliance to the connector based on the power supply signal and the identification signal and to start power supply to the transmission circuit unit.

In the following, embodiments of the present invention will be described in detail with reference to the drawings.

### First Embodiment

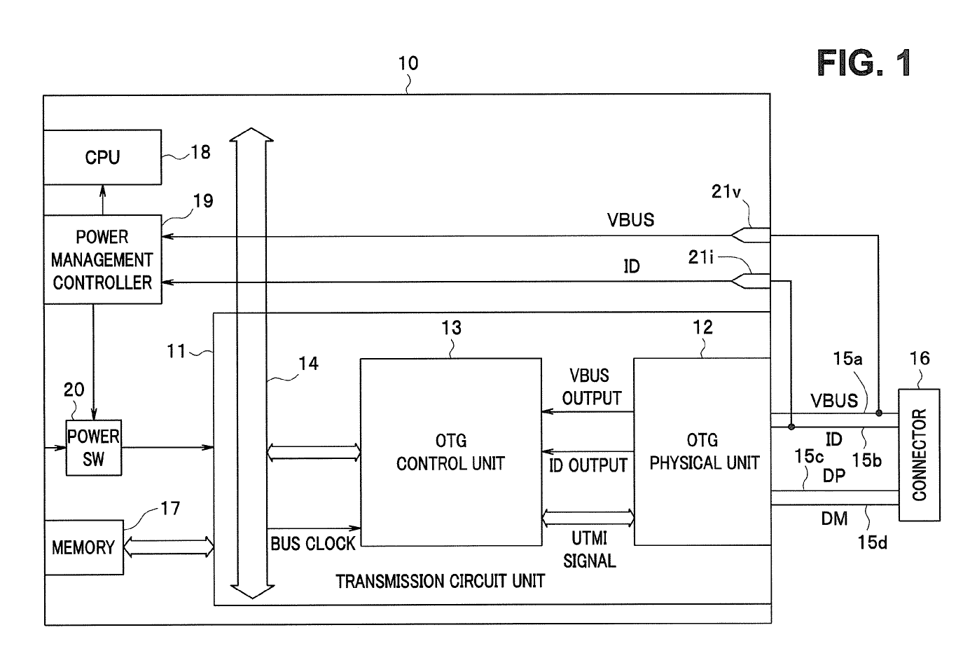

FIG. 1 is a block diagram showing a semiconductor device according to a first embodiment of the present invention. The present embodiment is applied to an LSI on which a USBOTG is mounted.

A semiconductor device 10 according to the present embodiment includes a transmission circuit unit 11 configuring an OTG controller according to USB 2.0 standard. Generally, a power saving mode in which each functional block that is mounted is driven at a low power consumption may be set in an LSI. However, with an LSI including an OTG controller function, a connection event of a USB appliance has to be detected even in the power saving mode. The LSI causes the entire system to shift from a power saving state (a power saving mode) to an operation state (a normal mode) after this event is detected, activates the system so as to enable communication with the connected USB device, initializes the OTG controller, and thereby performs communication.

Conventionally, to detect this connection event, it was necessary to place the OTG controller in a connection standby state at all times, to generate a connection event as an interrupt, and to notify a functional block managing the power of the entire LSI of the connection event. Thus, conventionally, power and clock had to be supplied to a functional block configuring the OTG controller even in the power saving mode of the LSI, and power was wastefully consumed.

Accordingly, with the semiconductor device 10 of the present embodiment, a component enabling notification of a connection event of a USB appliance is added to a power management controller 19, which is a functional block for managing the power of the semiconductor device 10, and a function of monitoring a connection event is realized at the power management controller 19, to thereby achieve power saving of the transmission circuit unit 11.

In FIG. 1, the transmission circuit unit 11 configures a USB 2.0 OTG controller that supports transfer in a High Speed (480 Mbps) mode, and is configured of an OTG physical unit 12 that achieves the function of a digital layer (a Link unit) and a physical layer (a PHY unit), and an OTG control unit 13 as a transmission control unit that controls the physical unit 12 and enables communication by USB.

A USB connector 16 includes four types of transmission paths defined in USB 2.0 standard. The four types of transmission paths according to USB 2.0 standard are a transmission path 15a for transmitting VBUS (power supply voltage), a transmission path 15b for transmitting an ID signal which is an identification signal of a USBOTG, and transmission paths 15c and 15d for transmitting differential data DP and DM. By connecting the USB connector of another USB appliance, not shown, to the USB connector 16, transmission by the transmission paths 15a to 15d is performed between the physical unit of the other USB appliance and the OTG physical unit 12. Transmission of UTMI signals according to UTMI standard is performed between the OTG physical unit 12 and the OTG control unit 13.

With the USBOTG, the USB appliance operating as the USB host transmits VBUS power supply voltage to the USB device. That is, the VBUS may be used as a power supply signal for determination of supply or non-supply of power source voltage, and whether the other USB appliance is a USB host or a USB device may be determined based on the voltage level of VBUS appearing in the transmission path 15a. Also, the USB appliance operating as the USB device transmits an ID signal of a low level (hereinafter referred to as “L level”) to the USB host. Accordingly, whether the other appliance is a USB device or not may be determined based on the voltage level of the ID signal.

The OTG physical unit 12 supplies to the OTG control unit 13, as the VBUS output, a signal of a high level (hereinafter referred to as “H level”) or the L level that is in accordance with the voltage level of the input end (not shown) for the VBUS transmitted via the connector 16. Also, the OTG physical unit 12 outputs to the OTG control unit 13, as the ID output, a signal of the H level or the L level that is in accordance with the voltage level of the input end (not shown) for the ID signal transmitted via the connector 16. Note that, in the case where the USB connector of another USB appliance, not shown, is not connected to the USB connector 16, the input end for the ID signal is pulled up to predetermined voltage, and the ID output is at the H level.

The OTG control unit 13 is to determine whether to set the transmission circuit unit 11 as the USB host or as the USB device depending on the VBUS output and the ID output from the OTG physical unit 12. That is, when the VBUS output stays at the L level and the ID output changes from the H level to the L level, the OTG control unit 13 sets the transmission circuit unit 11 to the USB host, and when the VBUS output changes from the L level to the H level and the ID output stays at the H level, the OTG control unit 13 sets the transmission circuit unit 11 to the USB device.

The OTG control unit 13 is connected to a system bus 14 inside the semiconductor device 10. Transmission of USB data between the OTG control unit 13 and a CPU 18, and between the OTG control unit 13 and a memory 17 is performed using this system bus 14. The CPU 18 is capable of performing setting so as to cause the transmission circuit unit 11 to operate as the USB host by setting a USB host mode where the transmission circuit unit 11 is caused to operate as the USB host, or of performing setting so as to cause the transmission circuit unit 11 to operate as the USB device by setting a USB device mode where the transmission circuit unit 11 is caused to operate as the USB device.

Switching between the power saving mode and the normal mode of the semiconductor device 10 is controlled by the power management controller 19. The power management controller 19 is capable of setting at least two states of power mode of whether to cause the semiconductor device 10 to operate in the power saving state (the power saving mode) or in the normal state (the normal mode).

In the present embodiment, in the power saving mode, the power management controller 19 stops power supply to the system bus 14 in the semiconductor device 10, and the OTG control unit 13 and the OTG physical unit 12 in the transmission circuit unit 11. In the example in FIG. 1, power is to be supplied to the transmission circuit unit 11 via a power switch (SW) 20, and the power management controller 19 stops power supply to the transmission circuit unit 11 in the power saving mode by controlling the power SW 20. Note that the power management controller 19 may realize power saving by giving a command for stopping operation that entails power consumption to the transmission circuit unit 11, instead of by controlling the power SW 20.

In the present embodiment, power supply to the transmission circuit unit 11 in the power saving mode is stopped by detection of a USB connection event by the power management controller 19. The power management controller 19 may detect the USB connection event as a recovery event from the power saving mode to the normal mode, and may resume power supply to the transmission circuit unit 11. Moreover, the power management controller 19 may issue a notification of whether to set the transmission circuit unit 11 to the USB host mode or to the USB device mode, based on the detection of the USB connection event.

In the present embodiment, input terminals 21v and 21i are mounted for detection of a connection event by the power management controller 19. The input terminal 21v is connected to an input end of the OTG physical unit 12 via the transmission path 15a, and the VBUS is supplied thereto. The input terminal 21i is connected to an input end of the OTG physical unit 12 via the transmission path 15b, and the ID signal is supplied thereto. The VBUS and the ID signal supplied to the input terminals 21v and 21i are provided to the power management controller 19.

The power management controller 19 detects the voltage level at the input terminal 21v (the voltage level of the VBUS), and also, the voltage level at the input terminal 21i (the voltage level of the input end of the OTG physical unit 12 that is connected to the transmission path 15b). By detecting the voltage level at the input terminal 21v or 21i, the power management controller 19 may determine whether a USB appliance is connected to the connector 16, and whether the connected USB appliance is a USB appliance in the USB host mode or a USB appliance in the USB device mode, in the same manner as the OTG control unit 13.

In the present embodiment, the power management controller 19 monitors the states of the input terminals 21v and 21i even when each functional block in the semiconductor device 10 is operating in the power saving mode. In the power saving mode, when a change in the state of the input terminal 21v or 21i is detected, the power management controller 19 determines that this change in the state to be a recovery event to the normal mode, and starts power supply to each functional block power supply to which was stopped, and also, starts supply of bus clock to the transmission circuit unit 11. The power management controller 19 determines whether a USB appliance connected to the connector 16 is a USB host or not, based on the state of the input terminal 21v.

A USB appliance operating in the host mode outputs VBUS power supply voltage. Accordingly, when detecting that the voltage level at the input terminal 21v has changed to voltage corresponding to the VBUS power supply voltage, the power management controller 19 determines that a USB appliance in the host mode is connected to the connector 16, and issues a notification to the CPU 18 for setting the device mode to thereby cause the transmission circuit unit 11 to be activated as a USB device. In response to this notification, the CPU 18 performs various settings for causing the transmission circuit unit 11 to operate in the device mode. Note that the transmission path 15b stays at the H level also when a USB appliance operating in the host mode is connected to the connector 16.

Also, in the case where a USB appliance operating in the device mode is connected to the connector 16, the transmission path 15b changes to the L level. Accordingly, when detecting that the voltage level at the input terminal 21v is low (VBUS power supply voltage is not supplied), and that the ID signal from the input terminal 21i has changed from the H level to the L level, the power management controller 19 determines that a USB appliance in the device mode is connected to the connector 16, and issues a notification to the CPU 18 for setting the host mode to thereby cause the transmission circuit unit 11 to operate as a USB host. In response to this notification, the CPU 18 performs various settings for causing the transmission circuit unit 11 to operate in the host mode.

The power SW 20 is controlled by the power management controller 19, and stops power supply to the transmission circuit unit 11 in the power saving mode. When the normal mode is recovered from the power saving mode, the power SW 20 is controlled by the power management controller 19 and starts power supply to the transmission circuit unit 11. The transmission circuit unit 11 starts operation by being supplied with power via the power SW 20. The OTG control unit 13 of the transmission circuit unit 11 thereby captures the VBUS output and the ID output from the OTG physical unit 12, and recognizes which of the USB host and the USB device is connected to the connector 16. Also, setting information for the host mode or the device mode is provided to the OTG control unit 13 by the CPU 18, and the OTG control unit 13 causes the transmission circuit unit 11 to operate in the host mode or in the device mode.

As described above, in the present embodiment, detection of a connection event is performed by the power management controller 19 in the power saving mode, and when a USB appliance is connected to the connector 16, the normal mode is recovered from the power saving mode, and power supply to the transmission circuit unit 11 is started, and also, a notification regarding which of the host mode and the device mode is to be set is provided to the CPU 18. The operation of the transmission circuit unit 11 is thereby started and mode setting is performed, and a state is achieved where data communication by the USBs is enabled.

Conventionally, to detect connection of a USB appliance, power supply to at least the CPU, the power management controller, the system bus, and the OTG control unit and the OTG physical unit in the OTG functional block was necessary, and also, to generate an interrupt, bus clock had to be supplied to the OTG functional block. Accordingly, power supply to the OTG functional block was necessary even in the power saving mode, and the power consumption was great.

On the other hand, in the present embodiment, connection of a USB appliance is detected by the power management controller 19, and when a USB appliance is not connected, operation of the transmission circuit unit 11 is not necessary, and power consumption may be reduced by stopping power supply to the transmission circuit unit 11.

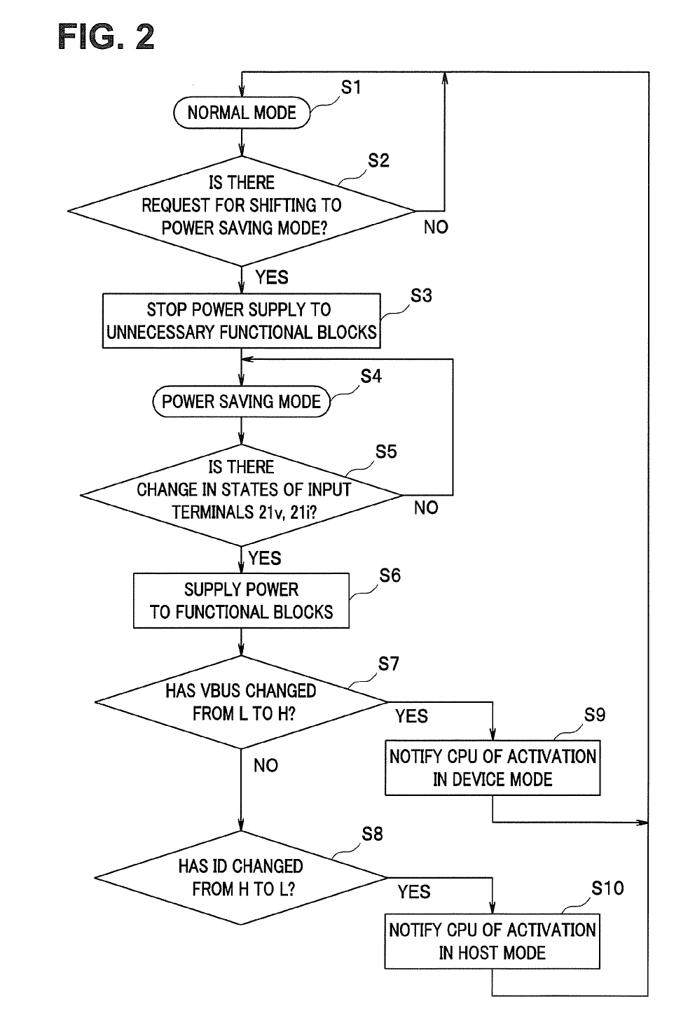

Next, an operation according to the embodiment configured in the above manner will be described with reference to the flowchart in FIG. 2. FIG. 2 shows the flow of management of the power state of the semiconductor device 10.

Now, the semiconductor device 10 is assumed to be operating in the normal mode (step S1). A request for shifting from the normal mode to the power saving mode is assumed to have been made in a state where a USB appliance is not connected to the connector 16. When it is detected in step S2 that a request for shifting to the power saving mode has been made, the power management controller 19 stops, in step S3, power supply to an unnecessary functional block that does not have to be operated. For example, the power management controller 19 stops power supply to the internal system bus 14, and the OTG control unit 13 and the OTG physical unit 12 in the transmission circuit unit 11 as the unnecessary functional blocks. The semiconductor device 10 thus operates in the power saving mode (step S4).

Next, a USB appliance is connected to the connector 16, and the normal mode is recovered from the power saving mode. In the present embodiment, the power management controller 19 realizes a recovery event by monitoring a change in the state of the input terminal 21v or 21i (step S5).

When detecting in step S5 that there is a change in the state of the input terminal 21v or 21i, the power management controller 19 determines that this change in the state is a recovery event to the normal mode, and resumes the power supply to the functional blocks power supply to which was stopped (step S6).

In steps S7 and S8, the power management controller 19 determines whether the change in the input terminal 21v or 21i is a change in the VBUS or a change in the ID signal. Here, it is assumed that a USB appliance operating in the host mode is connected to the connector 16. In this case, the ID signal is at the H level, and VBUS power supply voltage is supplied from the other USB appliance. When detecting in step S7 that the VBUS power supply voltage is supplied to the input terminal 21v, the power management controller 19 notifies the CPU 18 to activate the transmission circuit unit 11 in the device mode (step S9). The CPU 18 thereby outputs, via the bus 14, setting information for causing the transmission circuit unit 11 to operate in the device mode, and recovers the normal mode (step S1).

On the other hand, in step S6, the transmission circuit unit 11 starts operation by being supplied with power by the power SW 20. When detecting that a USB appliance operating in the host mode is connected to the connector 16 based on the VBUS output and the ID output from the OTG physical unit 12, the OTG control unit 13 sets the transmission circuit unit 11 to the device mode. Setting information for operating in the device mode is provided to the OTG control unit 13 by the CPU 18, and the OTG control unit 13 starts operation in the device mode. Thereafter, the transmission circuit unit 11 exchanges USB data with the USB appliance in the host mode, which is connected to the connector 16.

Also, it is assumed that a USB appliance operating in the device mode is connected to the connector 16 in the power saving mode. In this case, the VBUS power supply voltage is not supplied from the other USB appliance, and the ID signal changes from the H level to the L level. When detecting in step S8 that the ID signal of the input terminal 21i has changed from the H level to the L level, the power management controller 19 notifies the CPU 18 to cause the transmission circuit unit 11 to be activated in the host mode (step S10). The CPU 18 thereby outputs setting information for causing the transmission circuit unit 11 to operate in the host mode via the bus 14, and recovers the normal mode (step S1).

On the other hand, in step S6, the transmission circuit unit 11 is supplied with power by the power SW 20 and starts operation. When detecting that a USB appliance operating in the device mode is connected to the connector 16 based on the VBUS output and the ID output from the OTG physical unit 12, the OTG control unit 13 sets the transmission circuit unit 11 to the host mode. Setting information for operating in the host mode is provided to the OTG control unit 13 by the CPU 18, and the OTG control unit 13 starts operation in the host mode. Thereafter, the transmission circuit unit 11 exchanges USB data with the USB appliance in the device mode, which is connected to the connector 16.

In this manner, in the present embodiment, a connection event of a USB appliance is detected by the power management controller for performing power management for the semiconductor device, based on the VBUS and the ID signal input to the input terminals, and the power management controller may monitor connection of a USB appliance in the power saving mode, and may recover the normal mode. Accordingly, the power supply to the OTG functional block may be stopped in the power saving mode, and the power consumption may be reduced.

Also, the power management controller may determine whether a USB appliance connected to the connector is a host or a device, based on the VBUS and the ID signal input to the input terminals, and may notify the CPU of the same.

### Second Embodiment

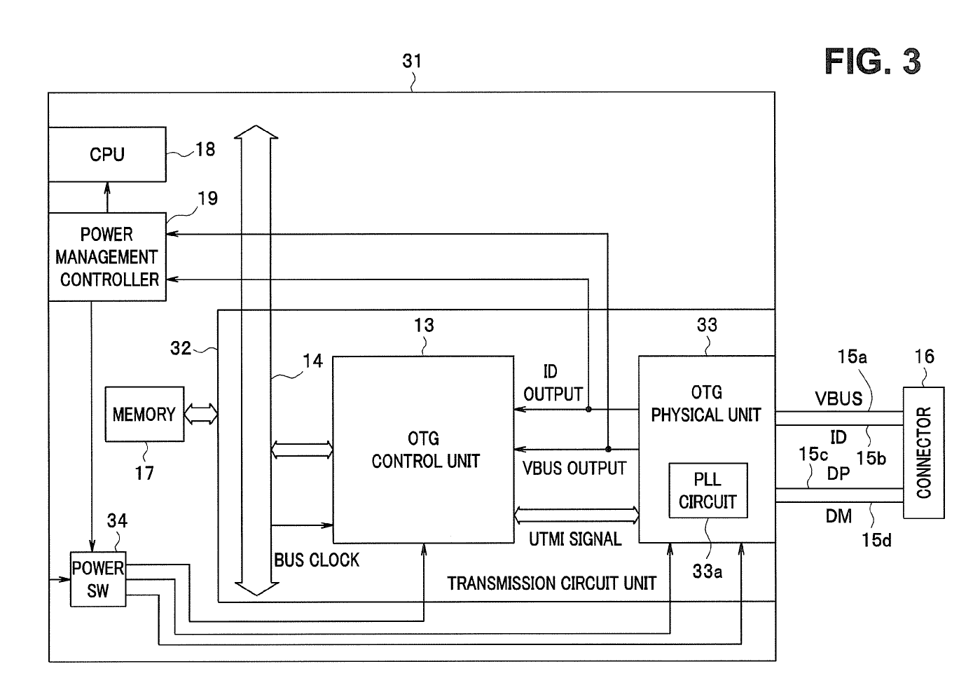

FIG. 3 is a block diagram showing a second embodiment of the present invention. In FIG. 3, the same structural components as in FIG. 1 are denoted with the same reference signs, and description thereof is omitted.

A physical unit configuring a general USBOTG is configured of an analogue block and a digital block, and the analogue block is provided with a PLL circuit for generating clock for enabling transmission/reception of data. This PLL circuit requires a relatively large amount of power to be driven, and if this PLL circuit may be stopped in the power saving mode and be placed in the power saving state, the amount of power to be consumed by the physical unit may be reduced to about 1/10 of the normal mode, for example. Also, by supplying power to the digital block in a case where the PLL circuit of the physical unit is in the power saving state, VBUS output and ID output based on VBUS power supply voltage and an ID signal may be performed.

Accordingly, in the present embodiment, in the power saving mode, by stopping power supply to an OTG control unit and shifting a PLL circuit of an OTG physical unit to the power saving state, power saving may be sufficiently performed, and also, detection of a connection event and a recovery event at a power management controller is performed by using the VBUS output and the ID output from the OTG physical unit. Thus, in the present embodiment, the input terminals 21v and 21i for capturing VBUS power supply voltage and an ID signal may be omitted.

A semiconductor device 31 shown in FIG. 3 is different from the semiconductor device 10 in FIG. 1 in that a transmission circuit unit 32 and a power SW 34 are adopted instead of the transmission circuit unit 11 and the power SW 20, respectively, and that the input terminals 21v and 21i are omitted. The transmission circuit unit 32 uses an OTG physical unit 33 instead of the OTG physical unit 12, and the OTG physical unit 33 supplies VBUS output and ID output to the OTG control unit 13 and the power management controller 19. The OTG physical unit 33 is different from the OTG physical unit 12 in that the state of power to a PLL circuit 33a in the analogue block may be independently controlled.

The power SW 34 is controlled by the power management controller 19, and is capable of stopping power supply to the OTG control unit 13 and of shifting the PLL circuit 33a in the analogue block of the OTG physical unit 33 to the power saving state in the power saving mode. Note that, also in the power saving mode, the OTG physical unit 33 is capable of having power supplied to the digital block by the power SW 34, and of outputting VBUS output and ID output.

Note that, in the power saving mode, the power management controller 19 may output a command to the OTG control unit 13 to stop operation that consumes power, instead of controlling the power SW 34. Also, in the power saving mode, the power management controller 19 may provide a suspend signal to the OTG physical unit 33 to stop operation of the PLL circuit 33a, instead of controlling the power SW 34. Note that when, in the OTG physical unit 33, the digital block is supplied with power and is capable of operation, and the PLL circuit 33a is in an operation stop state where power is not consumed, this is referred to as a suspend state.

The power management controller 19 is capable of detecting connection of a USB appliance to the connector 16, in the same manner as the OTG control unit 13, based on VBUS output and ID output by being provided with VBUS output and ID output by the OTG physical unit 33, and of determining whether the connected USB appliance is a USB host or a USB device.

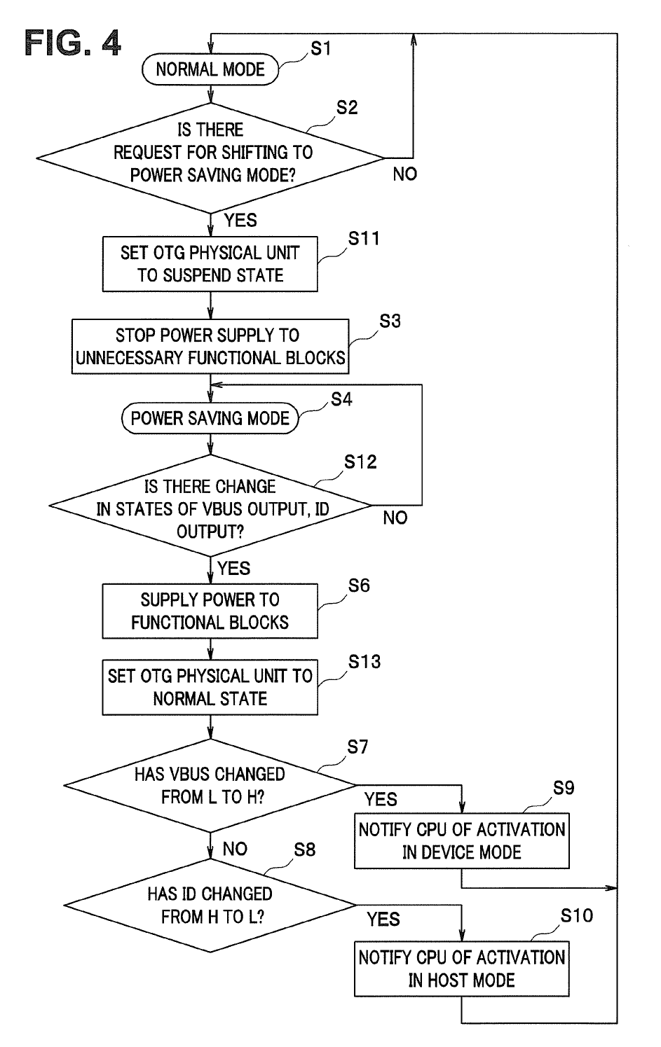

Other components are the same as those of the first embodiment. Next, an operation of the embodiment configured in the above manner will be described with reference to the flowchart in FIG. 4. FIG. 4 shows the flow of management of the power state of the semiconductor device 31. In FIG. 4, the same steps as in FIG. 2 will be denoted with the same reference signs, and description thereof will be omitted.

The present embodiment is different from the first embodiment in that the OTG physical unit 33 is set to a suspend state in step S11, when a request for shifting from the normal mode to the power saving mode is made in a state where a USB appliance is not connected to the connector 16.

When detecting in step S2 that a request for shifting to the power saving mode has been made, the power management controller 19 controls the power SW 34 and stops power supply to the PLL circuit 33a of the OTG physical unit 33 in step S11, and stops power supply to the internal system bus 14 and the OTG control unit 13 in the transmission circuit unit 11 in step S3. The semiconductor device 31 thereby operates in the power saving mode (step S4).

On the other hand, a recovery event from the power saving mode to the normal mode is realized by the power management controller 19 monitoring a change in the states of VBUS output and ID output (step S12). Power is supplied to the digital block of the OTG physical unit 33 also in the power saving mode, and the OTG physical unit 33 may perform VBUS output and ID output. When detecting a change in VBUS output or ID output from the OTG physical unit 33, the power management controller 19 determines that a recovery event to the normal mode has occurred, and starts power supply to each functional block in the semiconductor device 31 (step S6).

Also, the power management controller 19 controls the power SW 34 in step S13 to thereby resume power supply to the PLL circuit 33a of the OTG physical unit 33, and recovers the OTO physical unit 33 from the suspend state to the normal operation state.

Subsequent operation is the same as in the first embodiment, and the power management controller 19 determines whether the USB appliance connected to the connector 16 is operating in the host mode or the device mode based on VBUS output and ID output, and issues a notification according to the determination result to the CPU 18. The CPU 18 thereby outputs setting information for causing the transmission circuit unit 32 to operate in the corresponding mode.

Also, the OTG control unit 13 of the transmission circuit unit 32 determines whether the USB appliance connected to the connector 16 is operating in the host mode or the device mode based on VBUS output and ID output from the OTG physical unit 33, and sets its own device to the device mode when a USB appliance operating in the host mode is connected, and sets its own device as the host when a USB appliance operating in the device mode is connected, and starts operation in the set mode according to the setting information from the CPU 18.

The transmission circuit unit 32 thus shifts to the normal mode, and performs USB data communication with the USB appliance connected to the connector 16.

In this manner, according to the present embodiment, the power consumption is sufficiently reduced by stopping operation of the PLL circuit of the OTG physical unit in the power saving mode. A connection event and a recovery event may be detected by the power management controller 19 also in the power saving mode based on VBUS output and ID output from the OTG physical unit, and recovery from the power saving mode to the normal mode is enabled.

Note that, in the present embodiment, input terminals for capturing VBUS and ID signals do not have to be provided for detection of the connection event and the recovery event, and the semiconductor device may be miniaturized more than in the first embodiment. Moreover, in the case where a semiconductor device is already provided with an unused input terminal, if a semiconductor device based on the first embodiment is configured using this input terminal, there is an advantage that power supply to the entire transmission circuit unit may be stopped in the power saving mode.

Note that the present invention is not limited to the embodiments described above, and various modifications may be made in the course of embodiment within the scope of the present invention. Furthermore, the embodiments described above include inventions in various phases, and various inventions may be extracted by appropriately combining a plurality of structural elements disclosed. For example, if the problems described in the section of problems to be solved by the invention may be solved and the effect described in the section of effect of the invention may be achieved even if some of the structural elements are removed from all of the structural elements described in the embodiments, a configuration where such structural elements have been removed may be extracted as an invention.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A semiconductor device comprising:
a transmission circuit unit including a physical unit configured to receive, from a connector for connecting to an external appliance configured to transmit a power supply signal and an identification signal, the power supply signal and the identification signal, and a transmission control unit configured to be able to detect connection of the external appliance based on the power supply signal and the identification signal received by the physical unit, the transmission circuit unit being configured to be able to perform data communication with the external appliance; and
a power control unit configured to perform power control based on a power saving mode and a normal mode, the power control unit being configured to stop power supply to the transmission circuit unit in the power saving mode, and, to detect a connection event of the external appliance to the connector based on the power supply signal and the identification signal and to start power supply to the transmission circuit unit.

2. The semiconductor device according to claim 1, further comprising:
a pair of input terminals configured to capture, respectively, the power supply signal and the identification signal transmitted via the connector,
wherein the power control unit detects the connection event based on the power supply signal and the identification signal captured by the pair of input terminals.

3. The semiconductor device according to claim 2, wherein the power control unit detects the connection event based on voltage levels of the pair of input terminals.

4. The semiconductor device according to claim 1,
wherein the transmission circuit unit is capable of operating in a device mode in which communication is controlled by a counterpart appliance of data communication or in a host mode in which communication of the counterpart appliance of the data communication is controlled, and
wherein the power control unit outputs, to a CPU configured to control the transmission circuit unit, a notification for performing setting as to whether the transmission circuit unit is to be operated in the device mode or in the host mode, based on the power supply signal and the identification signal.

5. The semiconductor device according to claim 1, wherein
the power control unit is configured to stop a part of power supply to the transmission circuit unit in the power saving mode,
wherein the physical unit is configured to provide two outputs based, respectively, on the power supply signal and the identification signal received via the connector to the transmission control unit and the power control unit, and
wherein the power control unit detects the connection event based on the power supply signal and the identification signal supplied from the physical unit.

6. The semiconductor device according to claim 5,
wherein the transmission circuit unit is capable of operating in a device mode in which communication is controlled by a counterpart appliance of data communication or in a host mode in which communication of the counterpart appliance of the data communication is controlled, and
wherein at least one of the transmission control unit and the power control unit outputs, to a CPU configured to control the transmission circuit unit, a notification for performing setting as to whether the transmission circuit unit is to be operated in the device mode or in the host mode, based on the power supply signal and the identification signal.

7. The semiconductor device according to claim 5, wherein, in the power saving mode, the power control unit stops power supply to an entirety of the transmission control unit, and, stops power supply to a part of the physical unit, and detects the connection event based on the power supply signal and the identification signal received by the physical unit.

8. The semiconductor device according to claim 7, wherein the power control unit stops power supply to a PLL circuit in the physical unit.

9. A semiconductor device comprising:
a transmission circuit unit including a physical unit configured to receive, from a connector for connecting to an external appliance configured to transmit VBUS and an ID signal, the VBUS and the ID signal, and an OTG control unit configured to be able to detect connection of the external appliance based on the VBUS and the ID signal received by the physical unit, the transmission circuit unit being configured to be able to perform data communication with the external appliance; and
a power control unit configured to perform power control based on a power saving mode and a normal mode, the power control unit being configured to stop power supply to the transmission circuit unit in the power saving mode, and, to detect a connection event of the external appliance to the connector based on the VBUS and the ID signal captured via a pair of input terminals in the power saving mode and to start power supply to the transmission circuit unit.

10. The semiconductor device according to claim 9, wherein
the power control unit is configured to stop power supply to all of the OTG control unit and a part of the physical unit in the transmission circuit unit in the power saving mode, and, to detect a connection event of the external appliance to the connector based on the VBUS and the ID signal and to start power supply to the transmission circuit unit,
wherein the physical unit is configured to operate in the power saving mode and the normal mode, and to provide two outputs based, respectively, on the VBUS and the ID signal received via the connector to the OTG control unit and the power control unit, and
wherein the power control unit is configured to detect the connection event based on the VBUS and the ID signal supplied from the physical unit.

11. A power control method for a USBOTG including a transmission circuit unit including a physical unit configured to receive, from a connector for connecting to an external appliance configured to transmit VBUS and an ID signal, the VBUS and the ID signal, and an OTG control unit configured to be able to detect connection of the external appliance based on the VBUS and the ID signal received by the physical unit, the transmission circuit unit being configured to be able to perform data communication with the external appliance, the power control method comprising:
stopping, by a power control unit configured to perform power control based on a power saving mode and a normal mode, power supply to the transmission circuit unit in the power saving mode; and
capturing, by the power control unit, in the power saving mode, the VBUS and the ID signal transmitted via the connector by a pair of input terminals, respectively, detecting a connection event of the external appliance to the connector based on the captured VBUS and the captured ID signal, and starting power supply to the transmission circuit unit.

12. The power control method for a USBOTG according to claim 11, further comprising:
stopping, by the power control unit power supply to an entirety of the OTG control unit and a part of the physical unit in the transmission circuit unit in the power saving mode;
providing, by the physical unit, in the power saving mode, two outputs based, respectively, on the VBUS and the ID signal received via the connector to the power control unit; and
detecting, by the power control unit, in the power saving mode, a connection event of the external appliance to the connector based on the VBUS and the ID signal supplied from the physical unit, and starting power supply to all of the transmission circuit unit.
